(19) United States
(12) Patent Application Publication
(10) Pub. No.: US 2014/0207033 A1
(43) Pub. Date: Jul. 24, 2014

(54) VIBRATION APPARATUS FOR STIMULATING PARANASAL SINUSES

(71) Applicant: David J. Hillila, Superior, WI (US)

(72) Inventor: David J. Hillila, Superior, WI (US)

(21) Appl. No.: 14/062,370

(22) Filed: Oct. 24, 2013

Related U.S. Application Data
(63) Continuation of application No. 12/969,275, filed on Dec. 15, 2010, now abandoned.

(51) Int. Cl. A61H 23/02

(52) U.S. Cl. CPC A61H 23/02
USPC 601/46

(57) ABSTRACT

A vibration device includes a vibrating element positioned to stimulate the paranasal sinuses of a user when the user is wearing the device. The device includes a control assembly for powering the vibrating element, the control assembly including at least one battery, a control switch for varying the voltage supplied to the vibrating element, electrical wiring extending from the at least one battery to the control switch, and a printed circuit board including timing circuitry for controlling the vibration of the vibrating element and charging circuitry for charging a rechargeable battery, wherein the at least one battery, the electrical wiring, and the printed circuit board are mounted within a strap attached to the vibration device. A remote control receiver for varying the voltage supplied to the vibrating element and an antenna are also mounted within the strap.

### CROSS REFERENCE TO RELATED APPLICATIONS

This application is a continuation of U.S. patent application Ser. No. 12/969,275, filed Dec. 15, 2010, which claims the benefit of U.S. Provisional Patent Application Ser. No. 61/327,437, filed Apr. 23, 2010; U.S. Provisional Patent Application Ser. No. 61/297,966, filed Jan. 25, 2010; and U.S. Provisional Patent Application Ser. No. 61/286,692, filed Dec. 15, 2009, which applications are incorporated herein by reference in their entirety.

### FIELD

The inventive aspects of this disclosure pertain to devices for stimulating the paranasal sinuses of a human being for the release of nitric oxide into the respiratory tract. More particularly, the disclosure pertains to devices including vibration elements for transmitting vibrational waves to the paranasal sinuses through the bones of the face.

### BACKGROUND

Humming is known to vibrate the paranasal sinuses (i.e., cavities) of a human being. Studies (ref. Humming, Nitric Oxide and Paranasal Sinus Ventilation, Mauro Maniscalco M. D. Stockholm 2006) have shown that vibration of the paranasal sinuses increases nasal nitric oxide (NO) release into the human respiratory tract by causing a washout of NO from the sinuses. It has been found that the release of NO can increase up to 15-20 times its normal levels during humming in a healthy human being.

NO is a gas with antibacterial and ciliary properties. The increase in the levels of the released NO are believed to have health benefits such as alleviating sinus problems and headaches, healing wounds, increasing stamina, alertness, and calmness, and mitigating conditions such as erectile dysfunction. NO is known to be critically involved in the increase of blood flow and delivery of oxygen, by allowing blood vessels to relax and dilate. NO plays a fundamental role in keeping a body healthy and younger feeling and looking.

Depletion of NO can result in adverse health consequences. Lack of NO can result in premature aging of the skin tissue. Decreased levels of NO have been known to cause progressive growth of the prostate. One of the major causes of conditions such as erectile dysfunction is fleeting levels of NO, which normally acts as a neurotransmitter in nerve cells to control erections.

It is hypothesized that oscillating airflow produced by external vibration, at the resonance frequency of the sinuses would enhance sinus ventilation and thereby increase nasal NO levels.

Despite all of the benefits of increased release of NO in the human body, humming is not necessarily an easy exercise. Humming requires concentration and discipline. Studies have shown that humming needs to be performed for hours before it can lead to health benefits such as alleviated sinus problems. (ref. George Eby, Med Hypotheses. 2006; 66(4):851-4)

Practical solutions for oscillating airflow of the sinuses at their resonance frequency and increasing the levels of nasal NO released into the human respiratory tract are desired.

### SUMMARY

The following disclosure pertains to devices including vibration elements for transmitting vibrational waves to the paranasal sinuses through the bones of the face for increasing the levels of nasal NO released into the respiratory tract.

According to one example aspect, the disclosure relates to eyewear including vibration elements strategically placed to stimulate the paranasal sinuses. According to another example aspect, the disclosure relates to mouthware including vibration elements strategically placed to stimulate the paranasal sinuses. According to yet another example aspect, the disclosure relates to nosewear including vibration elements strategically placed to stimulate the paranasal sinuses. According to yet another example aspect, the disclosure relates to multiuse headwear/neckwear including vibration elements strategically placed to stimulate the paranasal sinuses.

### BRIEF DESCRIPTION OF THE DRAWINGS

The accompanying drawings, which are incorporated in and constitute a part of the specification, illustrate several aspects of the present disclosure and together with the description, serve to explain the principles of the disclosure. A brief description of the drawings is as follows:

FIG. 1 illustrates a front view of a device to be worn as eyewear having features that are examples of inventive aspects in accordance with the principles of the present disclosure;

FIG. 2 illustrates a side view of a frame of the device of FIG. 1;

FIG. 3 illustrates a first embodiment of a module housing a control system configured for use with devices such as those shown in FIGS. 1, 7C, 8, 8A, 8C, 9, 11A, 13A, and 17, the control system being battery-powered;

FIG. 3A illustrates a second embodiment of a module housing a control system configured for use with devices such as those shown in FIGS. 1, 7C, 8, 8A, 8C, 9, 11A, 13A, and 17, the control system being battery-powered;

FIG. 4 illustrates a third embodiment of a module housing a control system configured for use with devices such as those shown in FIGS. 1, 10, 13, and 14, the module configured for being plugged into a conventional wall outlet for power;

FIG. 5 illustrates a fourth embodiment of a module housing a control system configured for use with devices such as those shown in FIGS. 1, 10, 13, and 14, the module configured for being plugged into a conventional vehicle jack for power;

FIG. 6 illustrates the electrical circuit of an example control system configured for operating devices such as those shown in FIGS. 1, 7, 7A, 8, 8A, 8B, 8C, 9, 10, 11A, 12, 13, 13A, 14, 15, and 17;

FIG. 6A illustrates a second electrical circuit of an example control system configured for operating the devices such as those shown in FIGS. 7B, 10, 11A, 13, 13A, and 16;

FIG. 6B illustrates a third electrical circuit of an example control system configured for operating the devices such as those shown in 7C, 8, 8A, 8C, 9, 11A, 13A, and 17;

FIG. 7 illustrates a side view of a frame of a second embodiment of a device to be worn as eyewear having features that are examples of inventive aspects in accordance with the principles of the present disclosure, the device including a battery-operated control system integrally mounted within the frame;

FIG. 7A illustrates a side view of a frame of a third embodiment of a device to be worn as eyewear having features that are examples of inventive aspects in accordance with the principles of the present disclosure, the device including a battery-operated control system integrally mounted within eyewear tightening straps of the device;

FIG. 7B illustrates a side view of a frame of a fourth embodiment of a device to be worn as eyewear having features that are examples of inventive aspects in accordance with the principles of the present disclosure, the device including a battery-operated control system and an antenna integrally mounted within the eyewear straps, the device further including a wireless remote receiver containing an on/off switch, speed control, and vibration selection control integrally mounted within the frame;

FIG. 7C illustrates a side view of a frame of a fifth embodiment of a device to be worn as eyewear having features that are examples of inventive aspects in accordance with the principles of the present disclosure, the device including a battery-operated control system integrally mounted within eyewear tightening straps of the device;

FIG. 8 illustrates replaceable nose pads for use with eyewear devices such as the devices shown in FIGS. 1, 7, 7A, 7B, 7C, wherein the eyewear devices may include removable/replaceable nose pads, the vibrating replaceable nose pads shown with a battery-operated control module;

FIG. 8A illustrates a removable and/or interchangeable structure in the form of a vibration element for use with eyewear devices such as the devices shown in FIGS. 1 and 7;

FIG. 8B illustrates a second embodiment of a removable and/or interchangeable structure in the form of a vibration element with the battery and control system integrally mounted therewithin, the vibration element being for use with eyewear devices such as the devices shown in FIGS. 1 and 7;

FIG. 8C illustrates a third embodiment of a removable and/or interchangeable structure in the form of a vibration element for use with eyewear devices such as the devices shown in FIGS. 1 and 7;

FIG. 9 illustrates a device to be worn as nosewear having features that are examples of inventive aspects in accordance with the principles of the present disclosure;

FIG. 10 illustrates a perspective view of a device to be worn as mouthware having features that are examples of inventive aspects in accordance with the principles of the present disclosure;

FIG. 11 illustrates a top view of the device of FIG. 10;

FIG. 11A illustrates a second device to be worn as mouthware having features that are examples of inventive aspects in accordance with the principles of the present disclosure;

FIG. 12 illustrates a top view of a sixth embodiment of a device to be worn as eyewear having features that are examples of inventive aspects in accordance with the principles of the present disclosure, the device including a rechargeable battery-operated control system mounted to the frame, the batteries rechargeable through power from a conventional wall outlet;

FIG. 13 illustrates a perspective view of a device to be worn as headwear or neckwear having features that are examples of inventive aspects in accordance with the principles of the present disclosure, the device illustrated with an optional control module similar to those shown in FIGS. 3-5;

FIG. 13A illustrates a top view of a second embodiment of a device to be worn as headwear or neckwear having features that are examples of inventive aspects in accordance with the principles of the present disclosure, the device illustrated with the type of control module shown in FIG. 3A;

FIG. 13B illustrates a side view of the vibrator case of the device of FIG. 13A;

FIG. 14 illustrates a side view of a third embodiment of a device to be worn as mouthware having features that are examples of inventive aspects in accordance with the principles of the present disclosure;

FIG. 15 illustrates a front view of the mouthware device of FIG. 14;

FIG. 16 illustrates a front view of a fourth embodiment of a device to be worn as mouthware having features that are examples of inventive aspects in accordance with the principles of the present disclosure, the mouthware device including a remote control receiver and shown with a wireless remote control transmitter; and

FIG. 17 illustrates a fifth embodiment of a device to be worn as mouthware having features that are examples of inventive aspects in accordance with the principles of the present disclosure.

### DETAILED DESCRIPTION

Reference will now be made in detail to the exemplary aspects of the present inventive features that are illustrated in the accompanying drawings. Wherever possible, the same reference numbers will be used throughout the drawings to refer to the same or like parts.

The following disclosure relates to devices that are configured to simulate vibrations similar to those produced by humming therapy to increase the levels of nasal NO released into the human respiratory tract for exhalation. Devices of the present disclosure include strategically placed vibration elements (e.g., vibration motors, vibrators) that are configured to vibrate the paranasal sinuses (i.e., the maxillary sinuses, the frontal sinuses, the ethmoid sinuses, and the sphenoid sinuses), causing a washout of NO from the sinuses.

According to one example, the devices of the present disclosure relate to eyewear including vibration elements strategically placed to stimulate the paranasal sinuses. According to another example, the devices of the present disclosure relate to nosewear including vibration elements strategically placed to stimulate the paranasal sinuses. According to yet another example, the devices of the present disclosure relate to mouthware including vibration elements strategically placed to stimulate the paranasal sinuses. According to yet another example, the devices of the present disclosure relate to multiuse headwear/neckwear including vibration elements strategically placed to stimulate the paranasal sinuses. According to yet another example, the devices of the present disclosure relate to mouthware including vibration elements strategically placed to stimulate the paranasal sinuses while relaxing and stretching the masseter muscles and the temporomandibular joint.

Although a number of example structures and arrangements will be described herein with respect to the devices, other structures and arrangements will be familiar to one of ordinary skill in the art and the examples described herein should not be used to limit the inventive aspects of the disclosure.

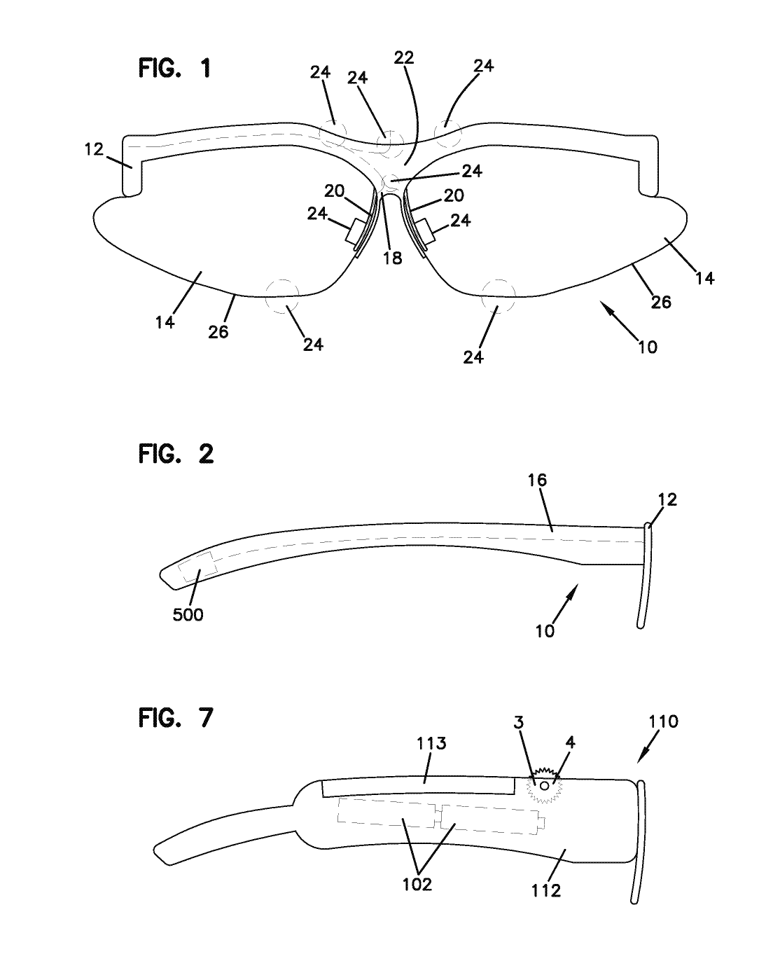

FIGS. 1-2 illustrate a first example embodiment of a device 10 having features that are examples of inventive aspects in accordance with the principles of the present disclosure. The device 10 is in the form of eyewear (e.g., eyeglasses). The device 10 includes a frame 12 that is configured to hold a pair of lenses 14 and to support the device 10 against the face of a person. The frame 12 includes portions 16 configured to rest over the ears. The ear portions 16 are normally provided with hinges and are foldable when the frame 12 is not in use. According to certain embodiments, there may be a switch incorporated into the hinge system so that when the ear portions are folded, the power will be off, and when they are opened, the circuit (as will be described and shown in further detail below) will be completed providing power or a ground to a certain portion of the circuit. The frame 12 also supports a nose piece 18 configured to sit on the bridge of the nose. The nose piece 18 may include a pair of nose pads 20 that are configured to contact the nasal bone for supporting the device 10 on the face. The nose pads 20 may be interchangeable to accommodate different sized/shaped noses. The frame 12 includes a bridge portion 22. The bridge portion 22 of the frame 12 is located between the lenses 14 and connects the right side of the frame 12 to the left side.

The device 10 illustrated is simply one example of eyewear and other types or designs of eyewear may be used to practice the inventive aspects of the present disclosure. For example, the eyewear may include different types of eyeglasses such as sunglasses, reading glasses, clear lens glasses (non-magnified), magnified glasses, those having removable, interchangeable lenses, etc.

Still referring to FIGS. 1-2, a single or a plurality of vibration element(s) 24 are mounted on the device 10 at strategic locations. As shown in the depicted example, each of the lenses 14 includes a vibration element 24 located adjacent the lower edge 26 of the lenses 14. The nose piece 18 includes a vibration element 24 on each of the nose pads 20 and a third vibration element 24 underneath the bridge portion 22 of the frame 12 between the nose pads 20. The frame 12 also includes a single or a plurality of vibration element(s) 24 on the bridge portion 22 of the frame 12.

The vibration element(s) 24 are placed strategically as shown over or near the frontal, and/or ethmoidal, and/or maxillary sinuses for the purpose of transmitting vibrational waves to these regions. It should be noted that the depicted device 10 illustrates only one example configuration for placement of the vibration elements 24 and that the vibration elements 24 can be positioned at different locations on the device 10 depending upon desired use. Any number of vibration elements 24 may be used depending upon the desired application. The vibration elements 24 may be integrally formed with the portions of the devices or may be attached in a removable manner. Moreover, it is contemplated that the attachment methods for the vibration elements 24 may provide for variable positioning of the elements 24 depending upon facial or other features of the user. For example, vibration elements 24 may be attached using hook and loop fasteners such as Velcro® so that their positions can be varied.

According to one example, the vibration elements 24 may include flat-coin 1.5 or 3-volt vibration motors. Vibration elements other than the flat-coin type motors may also be suitable for use with the devices disclosed herein. Vibration elements of any size or voltage may be used as long as the battery or other power supply voltage is adjusted accordingly.

According to one example, the vibration elements 24 may have a speed of approximately 7800 rpm. Means for reducing, varying, or pulsing the speed of the vibration elements 24 may be provided, as will be discussed in further detail. According to one example, the speed may be reduced to approximately 7800 rpm (with a frequency of 130 Hz) as the key to sinus health and the release of NO to vibrate the sinuses near their resonance frequency is typically in the neighborhood of 130 Hz. (Ref. Humming, Nitric Oxide and Paranasal Sinus ventilation, Mauro Maniscalco, M. D. Stockholm 2006)

As discussed above, portions of the eyewear device 10 and the vibration elements 24 provided thereon may be permanently mounted to the eyewear device 10 or may be removable or interchangeable. In embodiments wherein the device includes permanently mounted portions with vibration elements 24, the wiring associated with the vibration elements 24 may be provided as part of the frame 12. FIGS. 1-2 depict such an example.

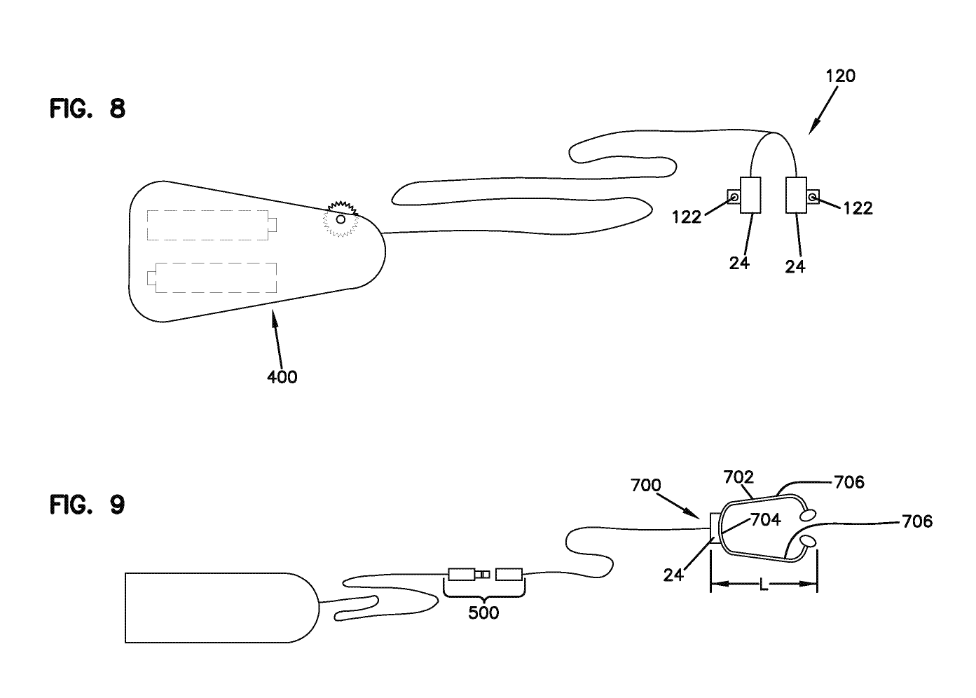

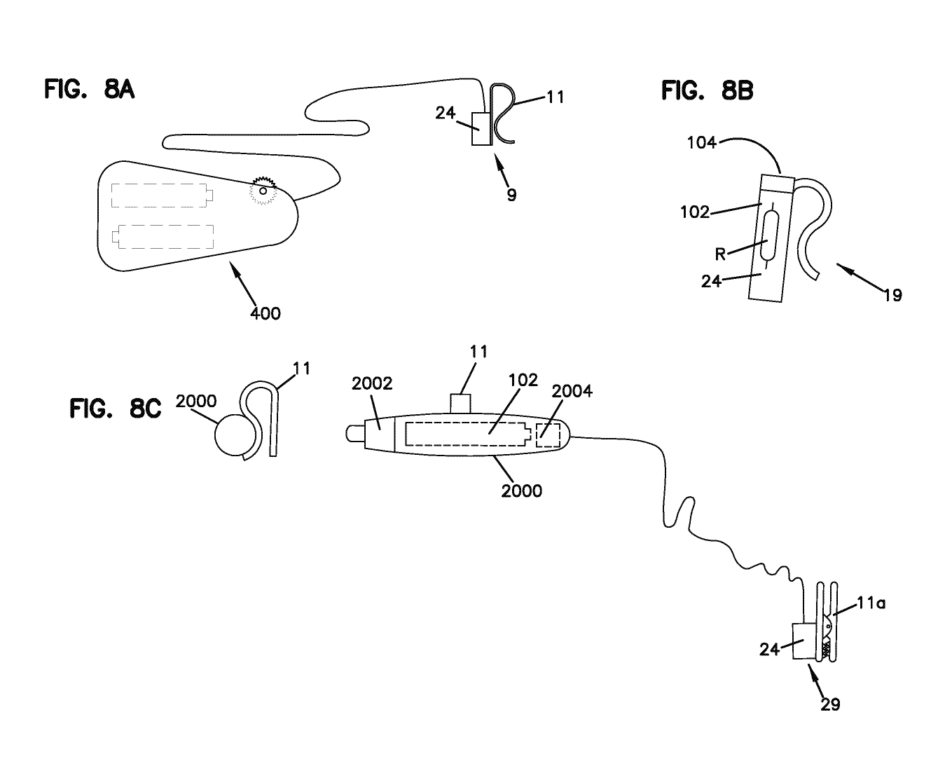

In embodiments wherein portions of the eyewear device are removable and/or interchangeable, the wiring for the vibration elements 24 is provided accordingly and may include removable connectorized portions. In certain embodiments, the removable and/or interchangeable portions may include separate external controls for the vibration elements 24. For example, FIG. 8 depicts replaceable nose pads 120 for use with devices such as eyewear, wherein the wiring for the vibration elements 24 of the nose pads 120 is attached separately to an external control module 400. The replaceable nose pads 120 may be provided with screw holes 122 for receiving threaded fasteners to attach the pads 120 to the nose piece of the frame, as commonly known in the art. In other versions of the replaceable nose pads known in the art, the nose pads may include portions that are externally threaded and configured to receive a nut for fastening the nose pads to the eyewear device.

FIG. 8A illustrates another embodiment of a removable and/or interchangeable structure 9 for use with a device such as the eyewear devices illustrated herein. The removable structure 9 is provided as a portable vibration element 24 that is configured to be attached to the eyewear device. In the depicted embodiment, the vibration element 24 is configured to be attached to the eyewear device via a spring tension clip 11. Other attachment means are certainly possible. The clip 11 is placed over the bridge portion 22 of the frame 12 to position the vibration element 24 adjacent the nasal bone of the user. Other locations on the eyewear device may be used depending upon the desired area of therapy. As shown, the removable and/or interchangeable structure 9 may be provided with an external control module 400 for operating the structure 9.

According to another version, the removable and/or interchangeable structure 19 may include an integrally built control module having, for example, an on/off switch 104, a battery 102, and a resistor R for operating a vibration element 24, as illustrated in FIG. 8B.

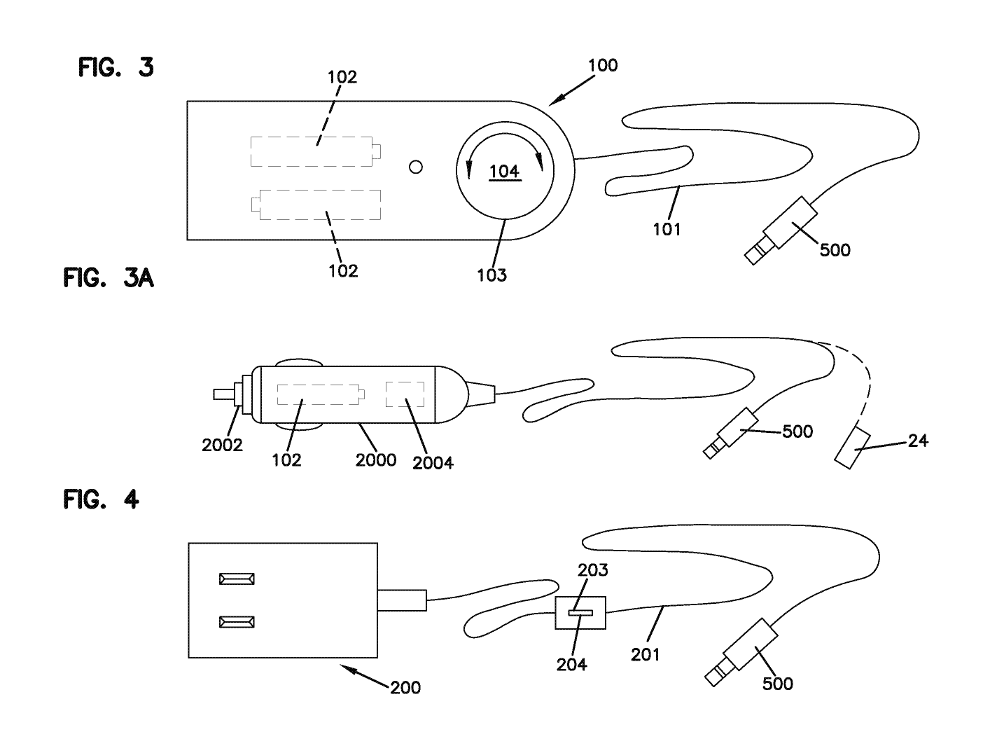

According to another version shown in FIG. 8C, the removable and/or interchangeable structure 29 may include a clip in the form of an alligator clip 11a for attachment to the bridge of the eyewear and may be provided with an external control module 2000 (discussed below and shown in FIG. 3A) for operating the structure 29. One or more spring tension clips 11 may be attached to the control module 2000 to temporarily attach control module 2000 to the ear portions of the eyewear.

As discussed above, the lenses of the eyewear devices discussed herein may be permanently mounted to the frames or may be removable and interchangeable such that one set of frames can support a number of different types of lenses. The lenses may be clear for watching TV, for use in dark areas, or during the evening. The lenses may be shaded for use in the sun. The lenses may be magnified such as for reading or non-magnified. The eyewear devices discussed herein may be worn during activities such as reading, watching TV, exercising, driving, etc.

As discussed above, controls may be provided to vary the operation of the vibration elements 24 on the devices. For example, means to control the frequency, the amplitude, and/or the status of the vibration elements 24 may be provided for the devices. The controls and the power sources therefore may be separate from the eyewear or built integrally into the frames or eyewear securing straps of the devices. The electrical portions of the eyewear devices may include the vibration elements, electrical wiring, potentiometers, fixed resistors, on/off switches, circuit boards, and wireless remotes. For controls and power sources that are built into or are a part of the frames or tightening straps of the eyewear devices, batteries may be used as the power source. For controls and power sources that are external to the device, the control systems and/or the power sources may be housed in external modules connected to the eyewear devices through cabling. In such embodiments, the control systems and the power sources may be disconnected from the eyewear device via a connector such that the eyewear may be used without a vibration option.

The eyewear device 10 illustrated in FIGS. 1-2 is constructed such that an external control and power system is used with the device. Such an external control and power system can be electrically connected to the device through a connector 500. The different types of control systems and power sources that may be used will be discussed in detail below.

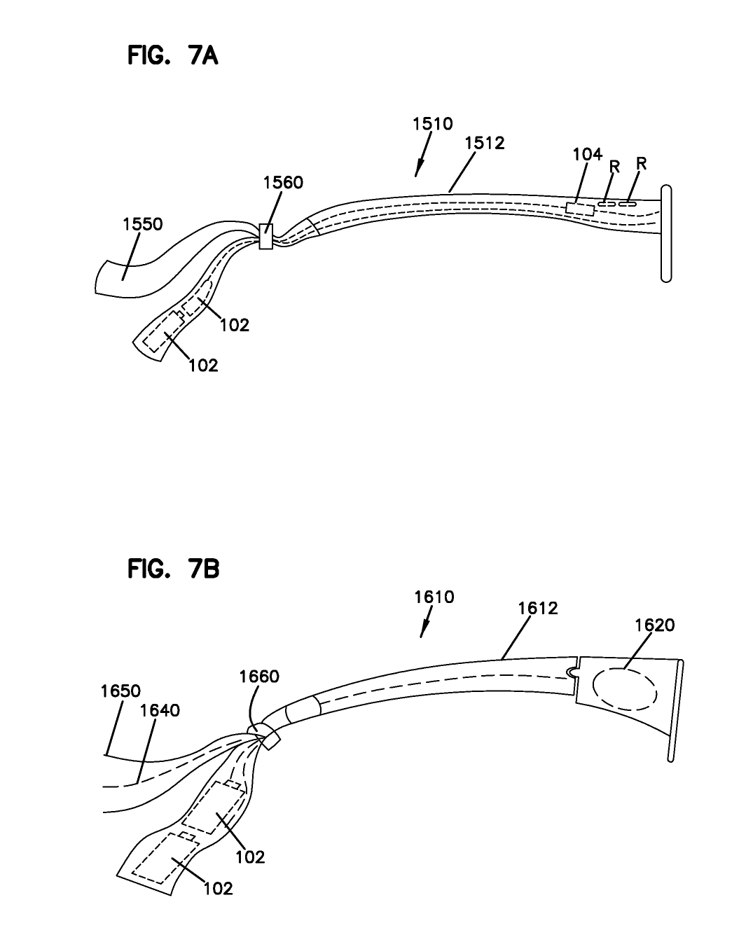

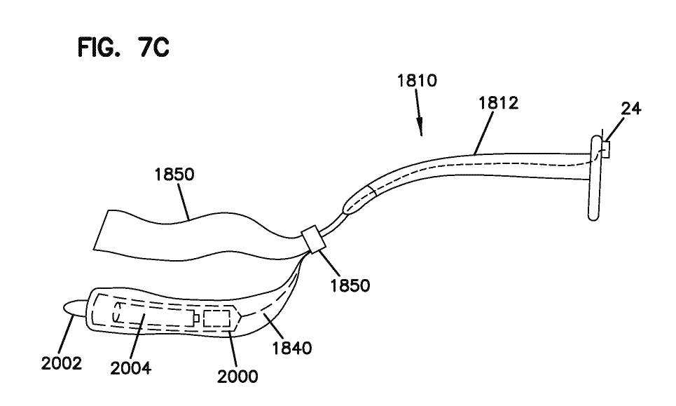

FIG. 7 illustrates an embodiment of an eyewear device 110 having a frame 112 including a battery-operated control system integrally mounted within the frame 112. The frame 112 illustrated in FIG. 7 may include a removable battery cover 113 to access the batteries 102 therein. An on/off switch 4 and a potentiometer 3 for varying the voltage going to the vibration elements 24 are also integrally mounted within the frame 112.

FIG. 7A illustrates an embodiment of an eyewear device 1510 having a tightening strap 1550. The tightening strap 1550 may include a tightening clip 1560. The eyewear device 1510 includes a battery power source integrally mounted within the strap 1550, wherein the batteries 102 may be removed and replaced from the ends of the straps. The frame 1512 illustrated in FIG. 7A may include an on/off switch 104 and a potentiometer or fixed resistors R for varying the voltage going to the vibration elements 24 also integrally mounted therewithin.

FIG. 7B illustrates another embodiment of an eyewear device 1610 having a tightening strap 1650 with a tightening clip 1660. The eyewear device 1610 includes a battery power source and an antenna 1640 integrally mounted within the strap 1650, wherein the batteries 102 may be removed and replaced from the ends of the strap. The frame 1612 illustrated in FIG. 7B may include a remote control receiver 1620 for turning on and off and varying the voltage going to the vibration elements 24 also integrally mounted within the frame 1612.

FIG. 7C illustrates another embodiment of an eyewear device 1810 having a tightening strap 1850 with a tightening clip 1860. The eyewear device 1810 includes a battery holder/control assembly or module 2000 integrally mounted within the strap 1850. One or more batteries 102 may be removed and replaced from the end cap. A switch device 2002 may be positioned at the end of the strap. A circuit board 2004 controls on/off functions, voltage variation, timing, and pulsing, to the vibration elements 24 also integrally mounted within the frame 1812. The circuit board 2004 may also house the charging circuit for charging a rechargeable battery.

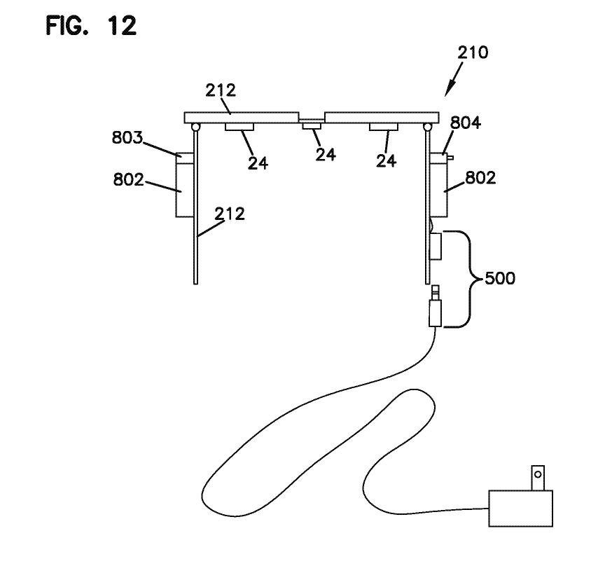

FIG. 12 illustrates an embodiment of an eyewear device 210 having a frame 212 that includes a battery-operated control system integrally mounted to the frame 212, wherein the batteries 802 are rechargeable through a power source provided by a conventional wall outlet. The power source may be connected to the rechargeable batteries through a connector 500. As shown, the device 210 includes an on/off switch 804 and a potentiometer 803 to vary the voltage going to the vibration elements 24.

As discussed previously, different types of control systems and different types of power sources may be used with the devices of the present disclosure. For those embodiments wherein a separate control system or a power source is used, the control system may be housed in external modules that may be electrically connected to the eyewear devices through a connector 500.

FIG. 3 illustrates an external control module 100 that houses a battery-operated control system. According to one example, the control module 100 may be connected to the device by dual conductor wiring 101 of about 1-5 feet in length. As noted above, the control system may provide means to control the frequency, the amplitude, and/or the status of the vibration elements, in combination or separately from each other. In one example, two 1.5-volt batteries 102 (connected in parallel for 1.5V motors and in series for 3V motors) may be used to control the vibration elements 24. A potentiometer 103 (i.e., thumbwheel or screwdriver-adjusted) or a group of fixed resistors may be used to apply varying voltages to the vibration elements 24. Such a thumbwheel is shown in the example illustrated in FIG. 3. An on/off switch 104 may be built into the circuitry to apply full battery voltage to the vibration elements 24. An on/off switch 104 may be used with or without a resistor. As discussed above, such a control system may be provided integrally as part of the eyewear device (FIG. 7).

FIG. 3A illustrates the battery holder/control assembly 2000 that may be integrally mounted within a strap, used as an external hand held module, or may be clipped to an article of clothing. The one or more batteries 102 may be removed and replaced from the end cap and the switch device 2002. The optional circuit board 2004 controls on/off functions, voltage variation, timing, and pulsing, to the vibration elements 24 that may be mounted in/on the eyewear, mouthware, nosewear, and/or head and neckwear devices shown. The circuit board 2004 may also incorporate a charging circuit for charging a rechargeable battery. It may have a connector 500 to be disconnected from any device which houses a vibrator 24 or it may be hardwired directly (e.g., as shown in FIGS. 7C, 8C, 11A, 13A, and 17) to any one or a number of vibrators 24.

FIG. 4 illustrates another type of an external module 200 that houses a control system for use with an eyewear device such as the device 10 of FIGS. 1-2. The external module 200 is configured for plugging into a conventional wall outlet for a power source. According to one example, the control module 200 may be connected to the device 10 by dual conductor wiring 201 of about 4-8 feet in length. In such an embodiment, a step-down transformer would reduce the voltage from 120V to the nominal operating voltage for powering the vibration elements 24. An on/off switch 204 with an optional variable resistor 203 may also be used as shown.

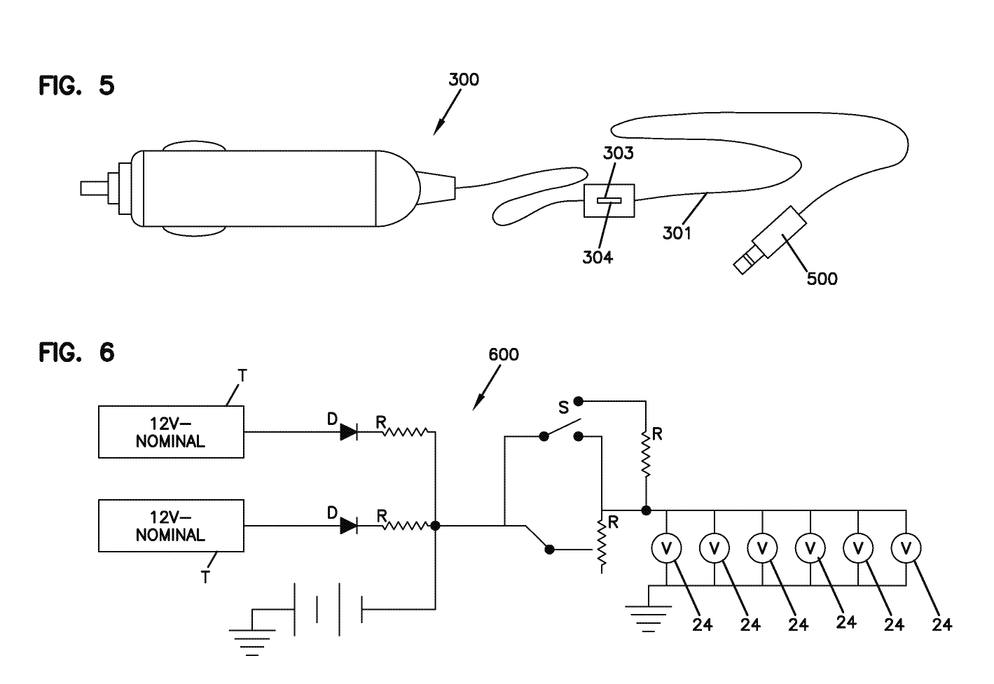

A module 300 similar to the external module 200 of FIG. 4 is shown in FIG. 5. The module 300 shown in FIG. 5 is configured for plugging into a conventional 12-volt vehicle power jack. A dual conductor wire 301 of about 5-6 feet in length may be used to connect the module to the device. Again, a voltage reduction system known to the art would be needed to reduce the voltage from 12V to the nominal operating voltage to control the voltage to the vibration elements 24. An on/off switch 304 with an optional variable resistor 303 may also be used as shown.

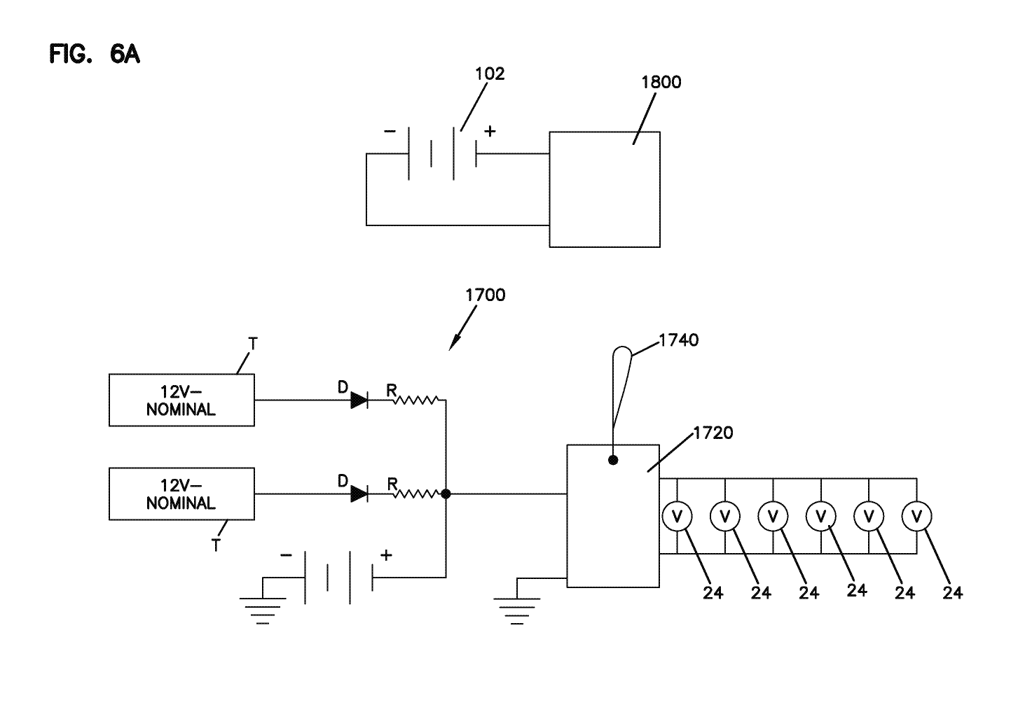

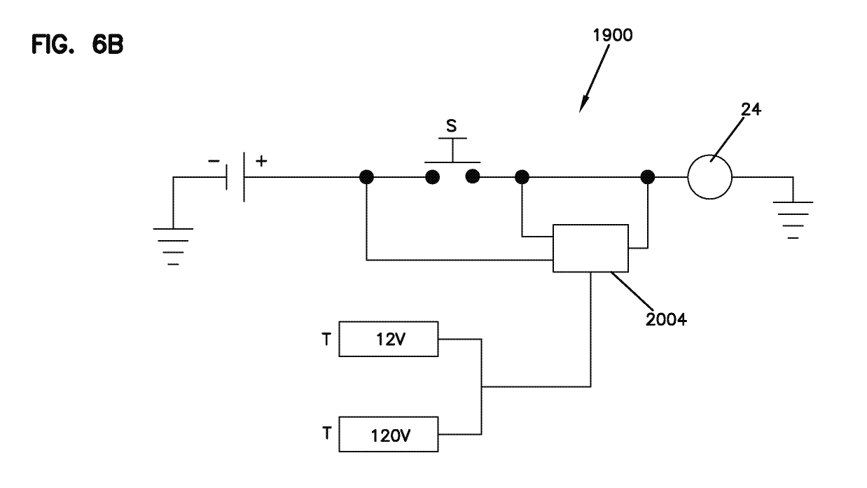

FIG. 6 illustrates an example control circuit 600 representative of the control systems shown in FIGS. 3, 4, and 5 configured for use with the devices of the present disclosure. The control circuit 600 may include step-down transformers T (type depending upon the voltage output of the power source), a combination of resistors R (variable or fixed), diodes D, and an optional on/off/on switch S. It should be noted that the control circuit 600 and the electronic elements described and illustrated in the present application are simply one example that may be used for operating the vibration elements of the devices herein. There are numerous possibilities for circuitry depending upon the type of vibration elements used and the control system desired.

It should be noted that the connector 500 mounted on the frame of the eyewear device may be constructed to accommodate all external power sources to operate the vibration elements 24 and to charge any rechargeable type batteries that may be installed (FIG. 12). The control circuitry may also incorporate a timing circuit to provide vibrations to occur at predetermined time intervals.

The control circuit 1700 illustrated in FIG. 6A is similar to that of FIG. 6 except that it utilizes a remote control receiver 1720 with an antenna 1740 and a remote control transmitter 1800 to control the voltage and timing of the vibration elements 24.

FIG. 6B illustrates an example control circuit 1900 representative of the control systems shown, for example, in FIGS. 3A, 7C, 8C, 11A, 13A and 17 configured for use with the devices of the present disclosure. The control circuit 1900 may include step-down transformers T (type depending upon the voltage output of the power source), an optional circuit board 2004, and an optional on/off or momentary switch S. It should be noted that the control circuit 1900 and the electronic elements described and illustrated in the present application are simply one example that may be used for operating the vibration elements of the devices herein. There are numerous possibilities for circuitry depending upon the type of vibration elements used and the control system desired. The optional circuit board 2004 controls on/off functions, voltage variation, timing, and pulsing, to the vibration elements 24. The circuit board 2004 may also incorporate a charging circuit for charging a rechargeable battery. It may have a connector 500 to be disconnected from any device which houses vibrator 24 or it may be hardwired directly to any one or a number of vibrators 24 as shown for a number of embodiments of the devices.

Preliminary testing using a handheld NIOX MINO® device (medical equipment for use in testing exhaled NO) showed an approximate increase in exhaled NO of about 15% with a device similar to those shown in FIGS. 1-2, 7, and 12. The NIOX MINO® test averages the exhaled NO over a 10-second period. Thus, the 15% increase is an average taken over a 10-second period. The spikes of NO of about 15-20 times the normal range are believed to last only a second or two when the device is turned on (similar to results experienced in humming, wherein the increases are much greater for the initial start of the humming). When the increase is averaged over a 10-second period, about a 15% increase is observed using a device similar to those illustrated and described in the present disclosure.

FIG. 9 illustrates a device 700 to be worn as nosewear having features that are examples of inventive aspects in accordance with the principles of the present disclosure. The nosewear device 700 is depicted as a nose clip. The nose clip 700 includes a body 702 defining a center portion 704 and a pair of spaced-apart arms 706 that extend from the center portion 704. The arms 706 are configured to be spring-biased toward each other and to be inserted into the nostrils with the spring tension holding the nose clip 700 in place. According to one embodiment, the length L of the body 702 is about ¾ inches. According to the depicted example, the center portion 704 of the nose clip 700 includes a vibration element 24. Other locations for the vibration elements 24 are also possible on the nose clip 700. The vibration element 24 is configured to transmit vibrations through the body 702 of the nose clip 700. The waves are transmitted through the septum and the nasal bone to the paranasal sinuses. As shown, the nose clip 700 may be fitted with a connector 500 such that external control systems and power sources similar to those shown in FIGS. 3-5 may be used with the nose clip 700.

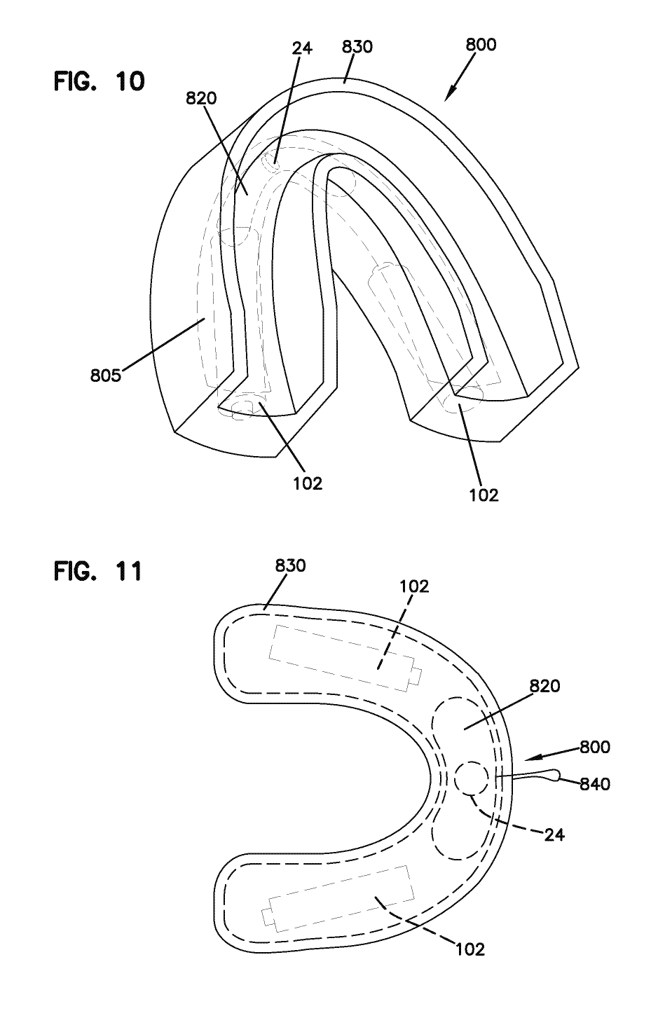

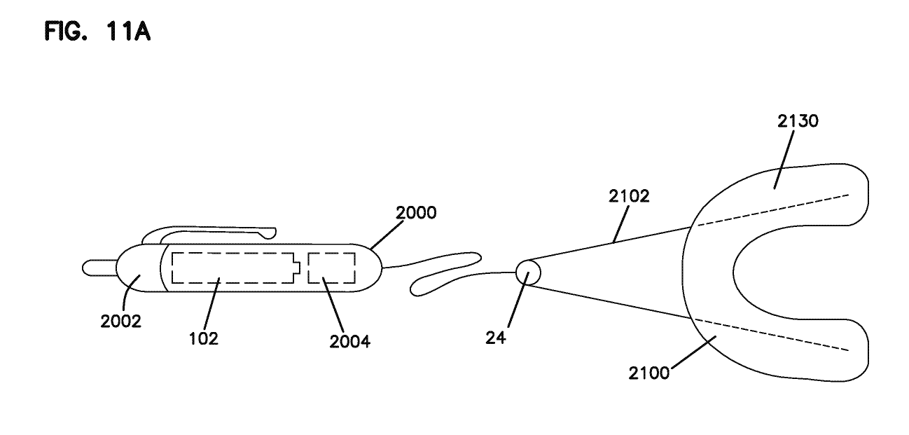

FIGS. 10-11 illustrate a device 800 to be worn as mouthware having features that are examples of inventive aspects in accordance with the principles of the present disclosure. The mouthware device 800 is depicted as a mouthguard. The mouthguard 800 may be boiled to fit, custom fit by a dentistry lab, or may be provided as a one-size-fits-all device. The mouthguard 800 may house vibration conductive material 805 (e.g., plate or rod) for radiating the vibrations caused by the vibration elements 24 located adjacent the metal structure 805. Vibrations through the teeth to the roof of the mouth may assist causing the paranasal cavities to release nitric oxide to the respiratory tract. The mouthguard 800 may be made of medical grade nontoxic material 830. The mouthguard 800 depicted includes an integral power source in the form of batteries 102, an on/off/on switch, and fixed resistors housed within the mouthguard 800. Optionally, the mouthguard 800 may include a wireless remote control receiver 820 with an antenna/retrieval cord 840 to control speed or vibration timing of the vibration element 24 therein. FIG. 11 illustrates a top view of the mouthguard 800 showing the location of the batteries 102, the optional remote receiver 820, the antenna 840, and the vibration element 24 of the example device. As noted above, the location and the number of the vibration elements 24 may be varied depending upon desired need and application. According to one example embodiment, once the vibration elements 24 are turned on (and the frequency and/or amplitude thereof are adjusted through an optionally provided variable resistor or a wireless remote transmitter and receiver), the mouthguard 800 is placed within the mouth of the user.

FIG. 11A illustrates another device 2100 to be worn as mouthware having features that are examples of inventive aspects in accordance with the principles of the present disclosure. The mouthware device 2100 is depicted as a mouthguard. The mouthguard 2100 may be boiled to fit, custom fit by a dentistry lab, or may be provided as a one-size-fits-all device. The mouthguard 2100 may house vibration conductive material 2102 (e.g., plate, plastic, or rod) for radiating the vibrations caused by the vibration element(s) 24 located adjacent the structure 2102, wherein the vibration element 24 is configured to be located outside the user's mouth. Vibrations through the teeth to the roof of the mouth may assist causing the paranasal cavities to release nitric oxide to the respiratory tract. The mouthguard 2100 may be made of medical grade nontoxic material 2130. The mouthguard 2100 depicted includes a control power source in the form of the control unit 2000 which houses one or more batteries 102, an on/off or momentary switch, and an optional control circuit board 2004.

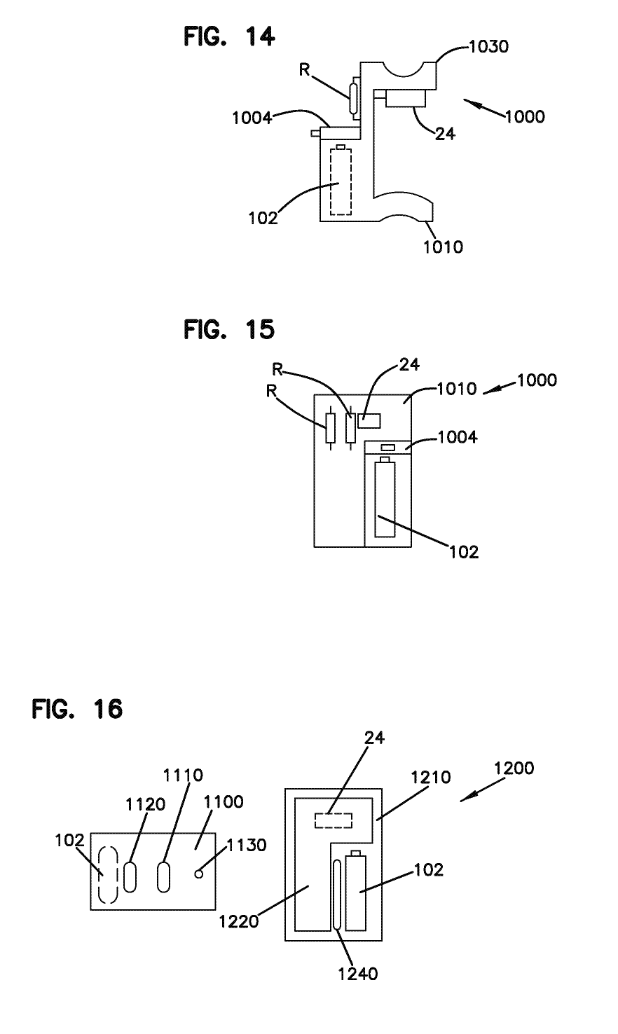

FIGS. 14-15 illustrate a third embodiment of a device 1000 to be worn as mouthware having features that are examples of inventive aspects in accordance with the principles of the present disclosure. FIG. 14 illustrates a side view of the device 1000 while FIG. 15 illustrates a front view. The mouthware device 1000 is configured such that the device 1000 includes vibration elements 24 strategically placed to stimulate the paranasal sinuses while also acting as a jaw stretching apparatus that relaxes and stretches the masseter muscles and the temporomandibular joint. The mouthware device 1000 is placed between the front teeth of a user, wherein an upper portion 1030 of the device is configured to contact the upper teeth and a lower portion 1010 of the device is configured to contact the lower teeth of the user. The device 1000 is designed and sized such that it stretches and relaxes the masseter muscles and the temporomandibular joint while providing vibration to aid in the release of nitric oxide. Portions of the device 1000, for example, the upper portion 1030 and the lower portion 1010 that contact the teeth of a user, may be coated with medical grade nontoxic material or rubber so as to provide comfort to the user.

Referring to FIG. 15, the device 1000 may include an integrally built control system having an on/off switch 1004, a battery 102, resistors R for controlling the vibration element 24. Optionally, as shown in a third embodiment of the device 1200 in FIG. 16, the device 1200 may be provided with a remote control transmitter 1100 having a battery 102, an on/off switch 1110, a speed/timing control switch 1120, and LED 1130 that is used to operate a remote control receiver 1220 of the device 1200 in conjunction with an antenna 1240 similar to those of the eyewear and mouthware devices previously discussed.

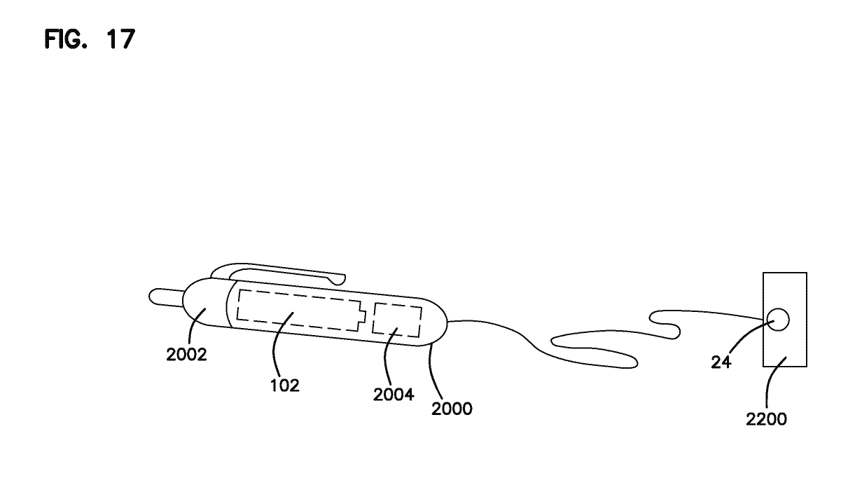

FIG. 17 illustrates a fourth embodiment of a device 2200 to be worn as mouthware having features that are examples of inventive aspects in accordance with the principles of the present disclosure. The mouthware device 2200 is configured such that the device 2200 includes vibration elements 24 strategically placed to stimulate the paranasal sinuses while also acting as a jaw stretching apparatus that relaxes and stretches the masseter muscles and the temporomandibular join. FIG. 17 illustrates the device 2200 as a mouth piece with a vibrator 24 embedded in a typical wine cork while using a pen-type control unit 2000 with optional circuit board functions as noted above.

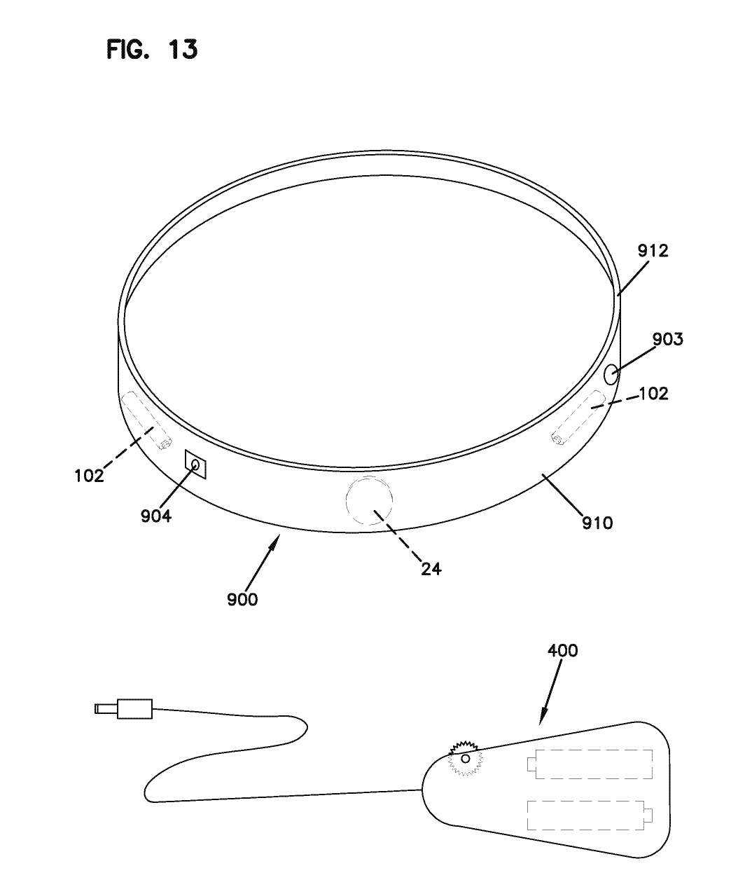

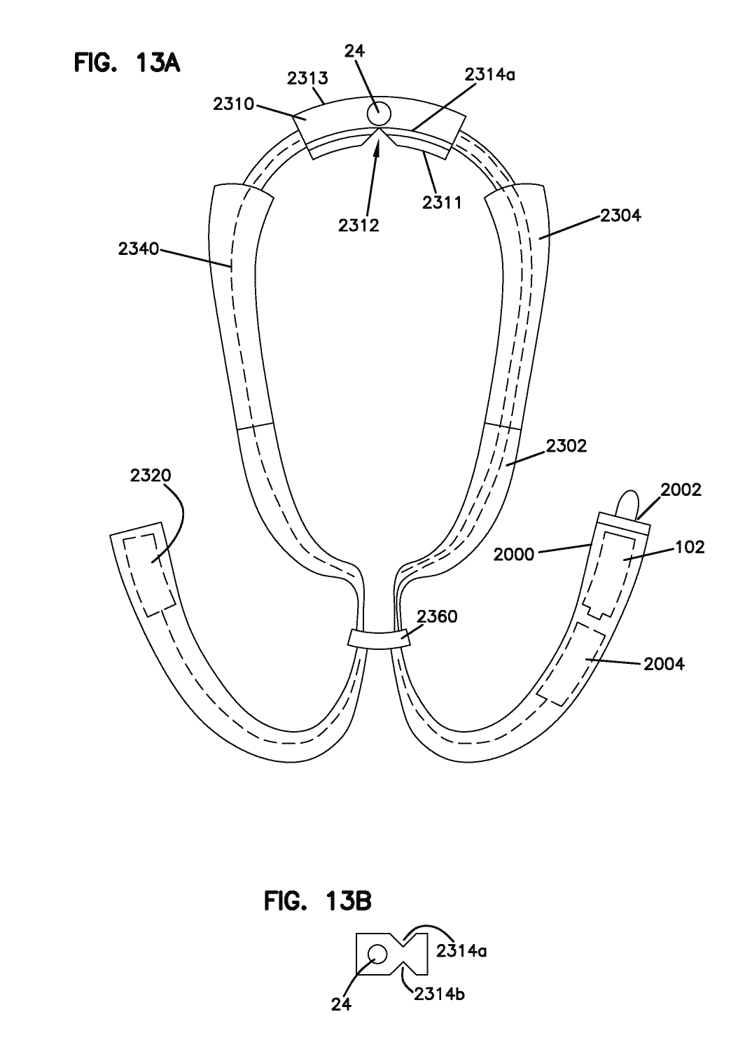

FIG. 13 illustrates a device 900 to be worn as headwear or neckwear having features that are examples of inventive aspects in accordance with the principles of the present disclosure. The device 900 is configured to hold at least one vibration element 24 that is strategically placed to stimulate the paranasal sinuses. According to the depicted example, the device 900 includes a vibration element 24 that may be placed between the eyebrows on the face of a person for transmitting vibrational waves to the frontal, and/or ethmoidal, and/or maxillary sinuses when the device 900 is worn by the user.

Although depicted as including one element 24, as discussed for other example embodiments above, the headwear/neckwear device 900 may include other number of vibration elements 24. The vibration element 24 may be integrally formed with portions of the device or may be attached in a removable manner. For example, the vibration element 24 may be attached using a hook and loop fastener such as Velcro® so that its position can be varied according to the user.

In the present example, the headwear/neckwear device 900 is depicted as a head/neck band 910 that defines a continuous loop. The band 910 is depicted as including a body 912 at least a portion of which is formed from elastic materials for varying the size of the head/neck band 910. In certain examples, the entire body 912 of the head/neck band 910 may include elastic materials and in other examples, only portions thereof may be formed from elastic materials, other areas formed from inelastic materials such as cloth.

In yet other examples of the headwear/neckwear device 900, rather than including a continuous loop band structure 910, the device 900 may be formed from a strip of material that is tied around the user's head or neck for strategically placing the vibration element 24 between the eyebrows. In such examples, the body of the device may or may not include elastic portions and may be made out of materials such as cloth. Such a device may also utilize hook and loop fastener such as Velcro® for joining the two ends. Other structures for the device 900 that are configured to place the vibration element(s) 24 at the desired location (e.g., between the eyebrows) on the face of the user are also possible.

As discussed above with respect to other example devices, the headwear/neckwear device 900 may include controls for varying the operation of the vibration element(s) 24. In the depicted device, a battery-operated control system is integrally mounted to or housed on the device 900. In the depicted embodiment, the head/neck band 910 forming the device 900 may include two batteries 102, a potentiometer 903, an on/off switch 904, and the wiring associated with the control system built integrally with or housed as part of the body 912 of the head/neck band 910. In certain examples, the body 912 of the band 910 may include pockets (e.g., on the outer surface of the body) for receiving and holding the batteries 102 thereon. Such pockets may be formed from elastic or inelastic materials (e.g., cloth). Other structures may be used to house the batteries 102 on the body 912 of the band 910.

As discussed for previous devices, rather than providing the control system on or as part of the headwear/neckwear device 900, the control system and the power source therefore may be provided externally to the device and may be housed in external modules. The external modules may be connected to the device 900 through cabling and connectorized couplings as discussed above. As shown in FIG. 13, one such example of an optional external control module that can be used with the headwear/neckwear device 900 is the module 400 that was previously described above and shown in FIGS. 8 and 8A. As illustrated in FIG. 13, the module 400 is powered by batteries. Other power sources may be used.

FIGS. 13A and 13B illustrate another device 2300 to be worn as headwear/neckwear having features that are examples of inventive aspects in accordance with the principles of the present disclosure. The device 2300 shown in FIG. 13A may be made from a combination of cloth 2302 and elastic 2304 materials. The device 2300 may incorporate a tightening piece 2360 for tightening the cloth part of the device around the neck or the head once worn. The device 2300 may also have a longer strap to wrap around any part of the body to provide an alternate function to NO release.

Although the device 2300 may include any of the control systems discussed above for controlling the voltage going to the vibrator element 24, the device 2300 is depicted with a control module similar to control module 2000 discussed above, wherein the control module is integrally placed within the cloth part 2302 of the device.

A device such as the example multi-use headwear/neckwear device 2300 shown in FIG. 13A may include one of more vibrators 24 encased in a waterproof plastic case 2310. The case 2310 may be covered by a softer medical grade silicone or rubber that may be safely put in the mouth of the user. The vibrator(s) 24 may be of various shapes and/or sizes. The vibrator case 2310 may include an indentation 2312 positioned on the inner surface 2311 thereof contoured to fit on the nasal bone of a user. The vibrator case 2310 may also include upper and lower indentations 2314a, 2314b, respectively, that are configured to receive the teeth of the user if the multi-use device 2300 is worn around the neck such that the vibrator case 2310 is positioned in the mouth of the user. In this manner, the device 2300 may be easily held on the bridge of the nose, or between the teeth while the cloth cinch strap portion 2302 is tightened around the back of the head or neck. As noted above, the configuration of the device 2300 for use as headwear/neckwear to be made of a combination of elastic and cloth cinch straps creates a wide opening for ease of putting the device 2300 over the head (or a large portion of the body) and then easily tightening around the neck (or a smaller portion of the body) using the tightening clip 2360. The elastic/cinch combination band using a tightening clip 2360 or a non-continuous band using a Velcro® type of an attachment mechanism discussed above for the device 900 of FIG. 13 may reduce any difficulties that may occur if one solid band of elastic was used. Since the batteries 102 may be housed in the cloth cinch strap 2302 part of the device, the elastic/cinch band combination may be desirable as this type of a configuration provides ease in keeping the battery case(s) from being in an undesirable location, such as pressing against the head or neck while lying down.

As depicted in FIG. 13A, the vibrator casing 2310 may be curved for ease in holding it in place for the desired location. The inner side 2311 of the curved case (when towards the body) may work well between the teeth, on the forehead, on the bridge of the nose, on the top or back of the head. The outer side 2313 of the curved vibrator case 2310 (when facing the body) may work well for the majority of the spine area or the center of the chest. Optionally built with extended straps, this type of a nitric oxide release apparatus could also have side benefits of wrapping around any other part of the body where healing or relaxing vibration is desired. The frequency and amplitude of this type of a multi-use vibrator band are believed to release nitric oxide from the paranasal cavities when placed on the bridge of the nose, between the teeth, on the skull, on the front of the throat, or on the back of the neck. All other locations of vibration may provide supplemental benefits of the product.

As noted above, the device 2300 illustrated in FIGS. 13A and 13B includes a battery holder/control assembly or module 2000 integrally mounted within the strap 2302. One or more batteries 102 may be removed and replaced from the end cap. A switch device 2002 may be positioned at the end of the strap 2302. A circuit board 2004 controls on/off functions, voltage variation, timing, and pulsing, to the vibration element 24. The circuit board 2004 may also house the charging circuit for charging a rechargeable battery. Optionally, as shown in FIG. 13A, the device 2300 may also include an antenna 2340 integrally mounted within the device and a remote control receiver 2320 for turning on and off and varying the voltage going to the vibration element(s) 24.

Although the multi-use headwear/neckwear device 900 shown in FIG. 13 has been depicted as including integrally formed control systems or external control systems configured to be connected to the devices through cabling, in other embodiments, the multi-use headwear/neckwear device 900 may include wireless remote control receivers with antennas for remote control operation, as also discussed above with respect to other devices in the present application, such as the device shown in FIGS. 13A and 13B.

It should be noted that the eyewear, the nosewear, the mouthware, and the headwear/neckwear devices disclosed herein may be used either separately or in any combination with each other depending upon the therapeutic results desired.

Although in the foregoing description, terms such as “top”, “bottom”, “front”, “back”, “lower”, “upper”, “right”, and “left” were used for ease of description and illustration, no restriction is intended by such use of the terms. The devices described herein can be used in any orientation, depending upon the desired application.

The above specification, examples and data provide a complete description of the manufacture and use of the inventive features of the disclosure. Many embodiments of the disclosure can be made without departing from the spirit and scope of the disclosure.

1. An eyewear device comprising:
a rigid frame configured to hold a pair of lenses, the frame including portions configured to rest over ears of a user when the user is wearing the eyewear device, the frame including a nosepiece configured to contact a nasal bone of the user when the user is wearing the eyewear device;
a pair of lenses removably attached to the frame;
a vibrating element positioned to contact the nasal bone of the user when the user is wearing the eyewear device;
a soft strap attached to the rigid frame, the strap configured for holding the eyewear device around a head of the user when the user is wearing the eyewear device;
a control assembly for powering the vibrating element, the control assembly including at least one battery, a control switch for varying the voltage supplied to the vibrating element, electrical wiring extending from the at least one battery to the control switch, and a printed circuit board including timing circuitry for controlling the vibration of the vibrating element and charging circuitry for charging a rechargeable battery, wherein the at least one battery, the electrical wiring, and the printed circuit board are mounted within the soft strap, wherein the at least one battery is removable from the soft strap and replaceable; and
a remote control receiver for varying the voltage supplied to the vibrating element and an antenna, wherein at least one of the remote control receiver and the antenna are mounted within the soft strap.

2. The eyewear device of claim 1, wherein the vibrating element is positioned on the nosepiece of the frame.

3. The eyewear device of claim 2, wherein the nosepiece is removably attached to the frame with a clip.

4. The eyewear device of claim 1, wherein the at least one battery is a rechargeable battery.

5. The eyewear device of claim 1, wherein both the remote control receiver and the antenna are mounted within the strap.

6. The eyewear device of claim 1, wherein the at least one battery is housed in a battery casing that includes the control switch and the printed circuit board for varying the voltage supplied to the vibrating element, the battery casing at least partially removable from the soft strap for accessing the battery.

7. The eyewear device of claim 1, further comprising at least two vibrating elements positioned adjacent the nasal bone when the eyewear device is worn by the user.

8. The eyewear device of claim 1, wherein the vibrating element includes a flat-coin type motor.

9. The eyewear device of claim 1, further comprising a tightening clip for tightening the soft strap around the head of the user when the eyewear device is worn by the user.

10. The eyewear device of claim 1, wherein the soft strap defines a pocket for removably holding the at least one battery.

11. A mouthware device comprising:
a mouthpiece configured to be positioned within a mouth of a user when the mouthware is worn by the user;
a vibrating element mounted to the mouthpiece, wherein the vibrating element is configured to be within the mouth of the user when the mouthware is worn by the user; and
a control assembly for powering the vibrating element, the control assembly including at least one battery for supplying voltage to the vibrating element, wherein the at least one battery is configured to be positioned outside the mouth of the user when the mouthware is worn by the user.

12. The mouthware of claim 11, wherein the vibrating element is fully encapsulated by the mouthpiece when the mouthware is inside the mouth of the user.

13. The mouthware of claim 11, wherein the control assembly further includes a control switch for varying the voltage supplied to the vibrating element, electrical wiring extending from the at least one battery to the control switch, and a printed circuit board including timing circuitry for controlling the vibration of the vibrating element.

14. The mouthware of claim 13, wherein the printed circuit board further includes charging circuitry for charging a rechargeable battery.

15. The mouthware of claim 11, further comprising a remote control receiver for varying the voltage supplied to the vibrating element and an antenna.

16. The mouthware of claim 11, further comprising a vibration conductive material for radiating the vibrations caused by the vibrating element.

17. The mouthware of claim 16, wherein the vibration conductive material includes a metallic structure fully encapsulated by the mouthpiece when the mouthware is inside the mouth of the user.

18. The mouthware of claim 11, wherein the mouthware is a mouthguard that is of the boiled to fit type.

19. The mouthware of claim 11, wherein the mouthpiece is sized for stretching masseter muscles and a temporomandibular joint of the user when the mouthware is worn by the user.

20. A multi-use vibration device configured to be worn around at least a head and a neck of a user, the vibrating device comprising:
a vibrator case including at least one vibrating element, the vibrating case defining an upper surface, a lower surface, an inner side and an outer side, wherein the vibrator case defines a first indentation positioned on the inner side contoured to fit a nasal bone of a user for positioning the vibrating element adjacent the nasal bone of the user, the vibrator case defining a second indentation on the upper surface and a third indentation on the lower surface, the second and third indentations configured to receive upper and lower teeth of a user, respectively, when the vibrating element is positioned adjacent a mouth of the user;
a strap attached to the vibrator case, the strap configured for holding the multi-use vibration device around at least the head or the neck of the user when the user is wearing the multi-use vibration device;
a control assembly for powering the vibrating element, the control assembly including at least one battery, a control switch for varying the voltage supplied to the vibrating element, electrical wiring extending from the at least one battery to the control switch, and a printed circuit board including timing circuitry for controlling the vibration of the vibrating element and charging circuitry for charging a rechargeable battery, wherein the at least one battery, the electrical wiring, and the printed circuit board are mounted within the strap, wherein the at least one battery is removable from the strap and replaceable; and
a remote control receiver for varying the voltage supplied to the vibrating element and an antenna, wherein at least one of the remote control receiver and the antenna are mounted within the strap.

21. The multi-use vibration device of claim 20, wherein the strap includes an elastic material.

22. The multi-use vibration device of claim 21, wherein the strap includes a cloth material.

23. The multi-use vibration device of claim 20, wherein the vibrator case is formed from a waterproof plastic material that encapsulates the vibrating element.

24. The multi-use vibration device of claim 20, further comprising a tightening clip for tightening the strap around the head or the neck of the user when the vibration device is worn by the user.

25. The multi-use vibration device of claim 20, wherein the at least one battery is housed in a battery casing that includes the control switch and the printed circuit board for varying the voltage supplied to the vibrating element, the battery casing at least partially removable from the strap for accessing the battery.

26. The multi-use vibration device of claim 20, wherein the strap defines a pocket for removably holding the at least one battery.

27. The multi-use vibration device of claim 20, wherein the at least one battery is a rechargeable battery.

28. The multi-use vibration device of claim 20, wherein the vibrating element includes a flat-coin type motor.
